(19) United States
(12) Patent Application Publication
(10) Pub. No.: US 2026/0340418 A1
(43) Pub. Date: Oct. 29, 2026

(54) FLEXIBLE EXPLORATION OF FUSED LAYER EXECUTION FOR ARTIFICIAL INTELLIGENCE INFERENCE ENGINES USING HYPERPARAMETER OPTIMIZATION

(71) Applicant: SAMSUNG ELECTRONICS CO., LTD., Suwon-si (KR)

(72) Inventors: Oren Kaikov, Tel-Aviv (IL); Yotam Avraham Platner, Tel-Aviv (IL); Eilon Regev, Tel-Aviv (IL); Amit Knoll, Tel-Aviv (IL)

(73) Assignee: SAMSUNG ELECTRONICS CO., LTD., Suwon-si (KR)

(21) Appl. No.: 19/187,400

(22) Filed: Apr. 23, 2025

(51) Int. Cl. G06N 3/0985

(52) U.S. Cl. CPC G06N 3/0985

(57) ABSTRACT

Methods and devices for performing neural network (NN) optimization, and a NN processing device for implementing an optimized NN. The method includes: obtaining a directed acyclic graph (DAG) that represents a NN model including a plurality of layers, wherein the DAG includes a plurality of nodes representing the plurality of layers, and a plurality of edges representing data paths between the plurality of layers; defining a plurality of hyperparameters corresponding to the DAG; performing a black box optimization on the NN model based on the DAG to optimize the plurality of hyperparameters; implementing the NN model using a NN processing device according to the optimized plurality of hyperparameters; and performing an inference operation based on input data using the NN processing device.

### BACKGROUND

### 1. Field

The disclosure relates to flexible exploration of fused layer execution for artificial intelligence (AI) inference engines using hyper parameter optimization (HPO).

### 2. Description of Related Art

A neural network (NN) may refer to an AI model in which a node and a synapse are repeatedly connected. In a process in which data moves from a current node to a subsequent node, various kinds of signal processing may occur according to corresponding synapses, and these signal processing processes may be referred to as layers. For example, a neural network may include various layers connected to each other in a relatively complicated manner.

Because various layers included in a neural network may perform a significant number of computations, which may be costly in terms of runtime, power, and system resources, various approaches for neural network optimization have been developed. For example, hardware accelerators and NN processors which may be used to process NNs may include an internal memory or cache in order to reduce off-chip data transfer and thus lower those costs, but this may be area-expensive.

Different compile-time decisions may be used to determine a trade-off between those costs. For example, one approach to reducing the off-chip data transfer may be referred as fused-layer execution, which may include executing multiple layers of the NN in a fused manner by forwarding intermediate data that is output by a layer to the next layer without transferring the intermediate data to off-chip memory. However, determining how to fuse the NN layers may be a challenging issue, that may depend on both the network architecture of the NN, the specific configuration of the NN processor, and the objective function that is being optimized.

### SUMMARY

Provided are methods and devices for performing neural network (NN) optimization, and NN processing devices for implementing NNs which are optimized according to the NN optimization.

Additional aspects will be set forth in part in the description which follows and, in part, will be apparent from the description, or may be learned by practice of the presented embodiments.

In accordance with an aspect of the disclosure, a method of performing neural network (NN) optimization includes: obtaining a directed acyclic graph (DAG) that represents a NN model comprising a plurality of layers, wherein the DAG comprises a plurality of nodes representing the plurality of layers, and a plurality of edges representing data paths between the plurality of layers; defining a plurality of hyperparameters corresponding to the plurality of edges; performing a black box optimization on the NN model based on the DAG to optimize the plurality of hyperparameters; implementing the NN model using a NN processing device according to the optimized plurality of hyperparameters; and performing an inference operation based on input data using the NN processing device.

In accordance with an aspect of the disclosure, a NN processing device includes: a NN processor configured to perform NN operations corresponding to a NN model comprising a plurality of layers; an internal memory; and an interface configured to communicate with an external memory; and at least one processor configured to: obtain input data and parameters of the NN model from the external memory, perform an inference operation on the input data using the NN processor according to an optimized plurality of hyperparameters to generate output data, and transfer the output data to the external memory, wherein the NN model corresponds to a DAG including a plurality of nodes representing the plurality of layers, and a plurality of edges representing data paths between the plurality of layers, wherein the optimized plurality of hyperparameters correspond to the plurality of edges, and are obtained by performing a black box optimization on the NN model based on the DAG.

In accordance with an aspect of the disclosure, an electronic device for performing neural network (NN) optimization includes: at least one processor; and a memory configured to store instructions which, when executed by the at least one processor, cause the electronic device to: obtain a directed acyclic graph (DAG) that represents a NN model comprising a plurality of layers, wherein the DAG comprises a plurality of nodes representing the plurality of layers, and a plurality of edges representing data paths between the plurality of layers, define a plurality of hyperparameters corresponding to the plurality of edges, perform a black box optimization on the NN model based on the DAG to optimize the plurality of hyperparameters, implement the NN model using a NN processing device according to the optimized plurality of hyperparameters, and perform an inference operation based on input data using the NN processing device.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating an electronic device, according to embodiments;

FIG. 2 is a block diagram illustrating a neural network processing device of FIG. 1, according to embodiments;

FIG. 3 is a flow diagram illustrating an example black box optimization (BBO) process, according to embodiments;

FIG. 4 is a block diagram illustrating an example of a directed acyclic graph (DAG), according to embodiments;

FIG. 5 is a block diagram illustrating an example of a DAG that is divided into subgraphs, according to embodiments;

FIG. 6 is a flowchart illustrating a process for performing NN optimization, according to embodiments;

FIGS. 7A and 7B are a flowcharts illustrating examples of performing an inference operation using an optimized NN, according to embodiments;

FIG. 8 is a block diagram illustrating a system including a NN processing device, according to embodiments; and

FIG. 9 is a block diagram illustrating an electronic device including a NN processing device, according to embodiments.

### DETAILED DESCRIPTION OF EMBODIMENTS

As discussed above, one approach for optimizing execution of a neural network (NN) model may include fused-layer execution, which may refer to executing multiple layers of the NN in a fused manner by forwarding intermediate data that is output by a layer to the next layer without transferring the intermediate data to off-chip memory.

However, determining how to fuse the NN layers may be a challenging issue, that may depend on both the network architecture of the NN, the specific configuration of the NN processor, and the objective function that is being optimized.

Accordingly, embodiments may relate to methods and devices for optimizing NN execution by representing the NN using a directed acyclic graph (DAG) including nodes representing layers and/or operations of the NN and edges representing the flow of data between the layers, and performing hyperparameter optimization (HPO) based on the DAG.

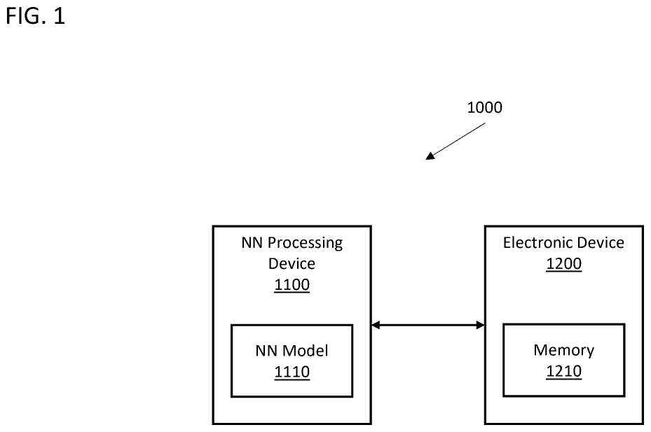

FIG. 1 is a block diagram illustrating an apparatus 1000 according to an embodiment. As shown in FIG. 1, the apparatus 1000 may include a NN processing device 1100 and an electronic device 1200. In an embodiment, the apparatus 1000 may be one of various computing systems, such as a personal computer (PC), a laptop computer, a smartphone, a tablet PC, and a digital camera. In an embodiment, the apparatus 1000 may be an edge device. For example, the apparatus 1000 may be an edge device, which does not include a network device, or which requires a real-time response, such as autonomous driving. For example, the apparatus 1000 may correspond to at least one of a drone, a robot device, such as an advanced drivers assistance system (ADAS), a digital camera, a digital video camera, a smart TV, a smartphone, a wearable device, a medical device, a mobile device, an image display device, measuring equipment, a navigation device, an Internet of Things (IoT) device, and other various types of electronic devices.

The NN processing device 1100 may perform NN computing operations. The NN processing device 1100 may perform a computing operation of a NN model, for example a computing operation corresponding to or associated with a NN model. For example, the NN processing device 1100 may perform NN operations on data from an outside, for example an outside of the NN processing device 1100 or an outside of the apparatus 1000, based on one or more machine learning (ML) algorithms, for example a convolutional NN (CNN) algorithm, a deep NN (DNN) algorithm, and any other type of ML or artificial intelligence (AI) algorithm. For example, the CNN may be trained for various purposes (e.g., general-use object recognition, position recognition, and the like) and implement the various purposes based on a trained model.

The electronic device 1200 may include a memory 1210. The a memory 1210 may be a volatile memory, such as dynamic random access memory (DRAM) or static random access memory (SRAM), for which data may be lost when power is off, or a nonvolatile memory (NVM), such as phase-change random access memory (PRAM), resistive random access memory (ReRAM), magneto-resistive random access memory (MRAM), or ferroelectric random access memory (FRAM), for which data may be maintained even when power is off. The memory 1210 may be used by the electronic device 1200 to store data or information corresponding to operations of the electronic device 1200.

In an embodiment, the NN processing device 1100 may access the memory 1210 of the electronic device 1200. The NN processing device 1100 may use the memory of the electronic device 1200. The NN processing device 1100 may store data related to a NN model, which may be referred to as NN model-related data, in the memory of the electronic device 1200. Accordingly, an amount of memory resources available for the NN processing device 1100 may increase. In an embodiment, the electronic device 1200 may share the memory 1210 with the NN processing device 1100. The memory 1210 of the electronic device 1200 may store NN model-related data. For example, the NN model-related data may include at least one from among a parameter, a weight, input data, intermediate data, output data, training data, verification data, and any other type of data associated with, corresponding to, or related a NN model. For example, the memory 1210 may store at least one of input data and a parameter to be provided to the NN processing device 1100. The memory 1210 may store at least one of intermediate data and output data received from the NN processing device 1100. Accordingly, the memory 1210 of the electronic device 1200 may be referred to as an external memory with respect to the NN processing device 1100.

In an embodiment, the NN processing device 1100 may implement an intended purpose by sequentially performing calculations or other operations corresponding to a plurality of layers of the NN model. The NN processing device 1100 may include a NN model 1110 (which may be, for example, a deep learning model). In some embodiments, the NN processing device 1100 may generate the NN model 1110. The NN processing device 1100 may train or learn the NN model 1110. The NN processing device 1100 may perform a computation of the NN model 1110 based on input data. The NN processing device 1100 may generate an information signal based on a computation result.

For example, the NN model 1110 may include at least one of various types of NN models, such as a CNN, a region-based CNN (R-CNN), a region proposal network (RPN), a recurrent NN (RNN), a stacking-based deep NN (S-DNN), a state-space dynamic NN (S-SDNN), a deconvolution network, a deep belief network (DBN), a restricted Boltzmann machine (RBM), a fully convolutional network, a long short-term memory (LSTM) network, a classification network, a generative adversarial network (GAN), a transformer, an attention network, and any other type of NN model, machine learning model, and artificial intelligence model.

The NN model 1110 may be trained and generated by the NN processing device 1100, and the trained NN model 1110 may be executed by the NN processing device 1100. However, embodiments are not limited thereto, and in some embodiments the NN model 1110 may be trained and generated by another device, for example the electronic device 1200 or any other device. Hereinafter, examples are provided in which the NN model 1110 may be a NN model having configuration parameters (e.g., a network topology, a bias, a weight, and the like) which may be (or may have been) determined through training, but embodiments are not limited thereto. The configuration parameters of the NN model 1110 may be updated through re-training in the NN processing device 1100, and the updated NN model 1110 (or converted NN model 1110) may be applied to the NN processing device 1100.

The electronic device 1200 may optimize an execution of the NN model 1110. For example, the electronic device 1200 may include or implement a NN compiler which may be used to compile the NN model 1110 for execution. According to embodiments, the electronic device 1200 may obtain a representation of the NN model 1110, and may perform an optimization process to optimize a performance of the NN model 1110 for execution by the apparatus 1000. For example, the NN compiler may be, or may include, a graph compiler, and the representation may include a directed acyclic graph (DAG). The electronic device 1200 may define hyperparameters corresponding to the DAG, and may perform a hyperparameter optimization (HPO) process to optimize performance of the NN model 1110 when the NN model 1110 is executed by the apparatus 1000. Examples of such an optimization process are described in greater detail below. Although examples are provided herein in which the optimization is performed by the electronic device 1200, embodiments are not limited thereto. For example, in some embodiments, the optimization may be performed by another device, for example another electronic device such as a server. In addition, the optimization may be performed as an offline process (e.g., not in real time).

Accordingly, an increase in a chip size due to an increase in a memory size may be prevented. The NN computing performance of the apparatus 1000 may be improved. The size of data which may be processed by the NN processing device 1100 may increase. For example the apparatus 1000 may provide improved performance. Examples of structure and operation of the apparatus 1000 according to an embodiment are described in more detail with reference to the drawings below.

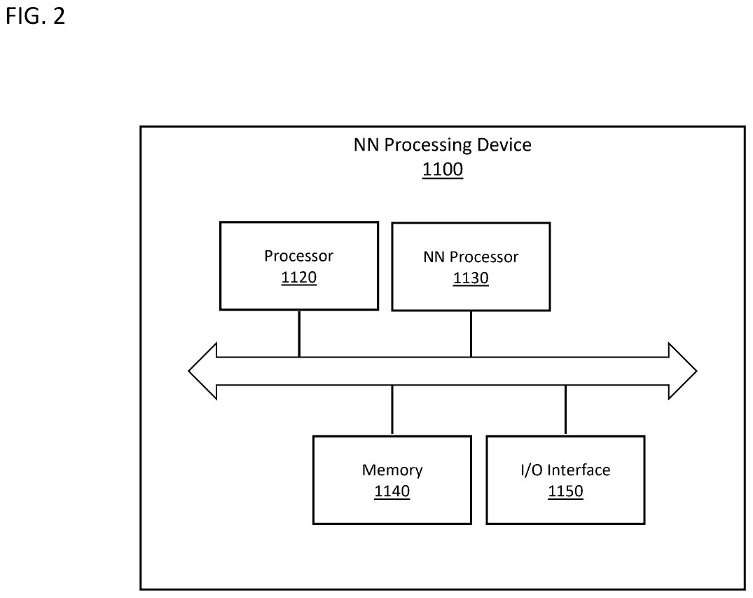

FIG. 2 is a block diagram illustrating the NN processing device 1100 of FIG. 1. As shown in FIG. 2, the NN processing device 1100 may include a processor 1120, a NN processor 1130, a memory 1140, and an input output (I/O) interface 1150. The processor 1120 may control a general operation of the NN processing device 1100. The NN processor 1130 may be a hardware accelerator configured to execute the NN model 1110. The NN processor 1130 may perform an intended NN computing operation (e.g., image classification, object recognition, and the like) by sequentially executing the plurality of layers of the NN model 1110. For example, the NN processor 1130 may correspond to at least one of a neural processing unit (NPU), a tensor processing unit (TPU), a neural engine, and the like, but embodiments are not limited thereto.

For example, as described above, the plurality of layers may include a convolutional layer, a fully connected (FC) layer, a rectified linear unit (ReLU) layer, and a pooling layer. In some embodiments, the plurality of layers may include element-based layers, such as a batch normalization layer, an element-wise layer, and a softmax layer. The NN processor 1130 may perform accelerated processing for each of the plurality of layers described above, through various schemes.

The memory 1140 may be a volatile memory, such as DRAM or SRAM, for which data may be lost when power is off, or a NVM, such as PRAM, ReRAM, MRAM, or FRAM, for which data may be maintained even when power is off. The memory 1140 may store various types of data to be used in the NN processor 1130. For example, the memory 1140 may be an input buffer or cache configured to store input data to be input to the NN processor 1130. The memory 1140 may be a parameter buffer or cache configured to store parameters to be used in the NN processor 1130. The memory 1140 may be a buffer or cache configured to store intermediate data generated during a computation of the NN processor 1130. The memory 1140 may be an output buffer or cache configured to store output data output from the NN processor 1130. Accordingly, the memory 1140 of the NN processing device 1100 may be referred to as an internal memory with respect to the NN processing device 1100.

The I/O interface 1150 may perform communication with another device, for example the electronic device 1200, to receive and transmit information. In some embodiments, the memory 1140 may not be large enough to store all of the NN model-related data used for execution of the NN model 1110. Accordingly, the NN processing device 1100 may transmit and receive NN-model related data to and from the memory 1210 of the electronic device 1200. For example, the I/O interface 1150 may receive at least one of input data and a parameter to be provided to the NN processor 1130 from the memory 1210. The memory 1210 may transfer intermediate data to the memory 1210 after the intermediate data is generated by a layer of the NN model 1110, and may receive the intermediate data from the memory 1210 to be provided as input to a next layer of the NN model 1110. In addition, the memory 1210 may transfer output data to the memory 1210 after it is generated by the NN model 1110.

As discussed above, the electronic device 1200 may perform an optimization process such as an HPO process to optimize performance of the NN model 1110 when the NN model 1110 is executed by the apparatus 1000.

HPO may refer to a process for tuning and selecting configuration parameters (e.g., hyperparameters) that control the performance of algorithms, models, or systems. These hyperparameters may be external to the model or algorithm being optimized, and may be set prior to the actual operation or execution. For example, a parameter may affect the functionality of a system, model, or algorithm, and a hyperparameter may affect performance of the system, model, or algorithm. HPO may be used to identify hyperparameter values that yield an optimal outcome for a particular problem or task, as defined by a specific performance metrics, for example a particular objective function.

One example of HPO may be referred to as block box optimization (BBO). BBO may refer to a process for optimizing functions or systems having internal structure or workings are unknown or too complex to model directly. According to BBO, the function or system being optimized may be treated as a “black box”, and a BBO process may be performed by iteratively evaluating the input-output behavior of the function or system without requiring any insights into the internal mechanisms of the function or system. BBO techniques may be used to perform HPO, where the goal is to discover optimal hyperparameters by systematically exploring a search space using approaches such as random search, Bayesian algorithms, genetic algorithms or other evolutionary algorithms, and statistical algorithms, based on performance feedback from the system or function being optimized.

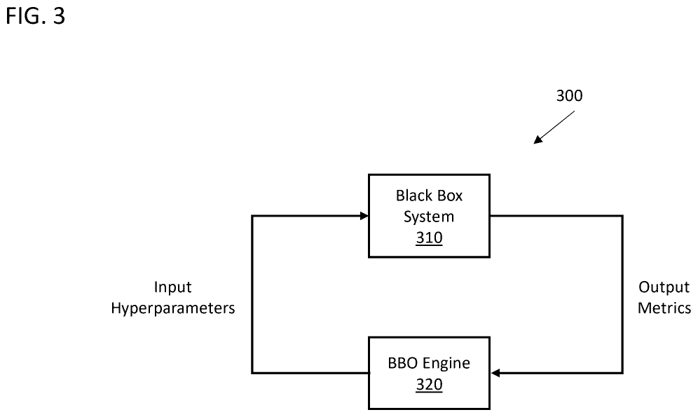

FIG. 3 is a flow diagram illustrating an example BBO process, according to embodiments. As shown in FIG. 3, according to the BBO process 300, input parameters (e.g., hyperparameters) may be applied to a system or function which may be referred to as a black box (BB) 301. The BB 310 may be executed or performed according to the input parameters, and corresponding output metrics may be measured or determined. The output metrics may be provided to a BBO engine 320, which may analyze the output metrics to determine a new set of input parameters. For example, the BBO engine 320 may determine the new set of input parameters by evaluating the output metrics according to an objective function. The BB 310 may then be executed or performed according to the new set of input parameters, and a new set of output metrics may be then measured or determined. Accordingly, the BBO process 300 may iteratively evaluate a performance of the BB 301 based on various parameters to determine optimum parameters for execution according to the objective function.

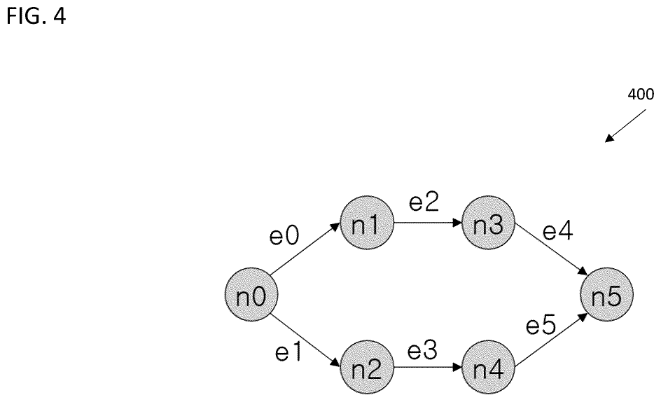

FIG. 4 is a block diagram illustrating an example of a DAG, according to embodiments. As discussed above, the electronic device 1200 may perform the optimization on the NN model 1110 by obtaining a representation of the NN model 1110, which may for example be a DAG. A DAG may be a graph structure that includes nodes and directed edges. In a DAG, the edges may have a direction, and there may be no cycles, which may mean that it is impossible to start at any node and follow the directed edges to return to the same node. According to embodiments, a DAG may be used to model the flow of operations and data within a NN model such as the NN model 1110. For example, each node in the DAG may corresponding to a layer of the NN model 1110. Accordingly, each node in the DAG may represent an operation or computation in the NN model 1110, such as at least one of a matrix multiplication, a convolution, and an activation function. These operations may be used to represent building blocks of the NN model 1110, and may define how the data is processed and transformed as it moves through the network. The directed edges in the DAG may represent the data dependencies between these operations, for example how the data is passed from one node to another.

As shown in FIG. 4, the DAG 400 may include a node n0, a node n1, a node n2, a node n3, a node n4, and a node n5. In addition, the DAG 400 may include an edge e0 connecting the node n0 to the node n1, an edge e1 connecting the node n0 to the node n2, an edge e2 connecting the node n1 to the node n3, an edge e3 connecting the node n2 to the node n4, an edge e4 connecting the node n3 to the node n5, and an edge e5 connecting the node n4 to the node n5.

Accordingly, the DAG 400 may indicate that, after a computation or operation corresponding to the node n0 is executed, intermediate data generated by the node n0 is provided as input to the node n1 and the node n2. The DAG 400 may also indicate that, after a computation or operation corresponding to the node n1 is executed, intermediate data generated by the node n1 is provided as input to the node n3. The DAG 400 may also indicate that, after a computation or operation corresponding to the node n2 is executed, intermediate data generated by the node n is provided as input to the node n4. The DAG 400 may also indicate that, after a computation or operation corresponding to the node n3 is executed, intermediate data generated by the node n3 is provided as input to the node n5. The DAG 400 may also indicate that, after a computation or operation corresponding to the node n4 is executed, intermediate data generated by the node n4 is provided as input to the node n5.

As discussed above, the memory 1140 included in the NN processing device 1100 (e.g., the internal memory) may not be large enough to store all of the NN-model related data used by the NN processing device 1100 to execute the NN model 1110. Accordingly, the NN processing device 1100 may store at least some of the NN model-related data in the memory 1210 of the electronic device 1200 (e.g., the external memory). However, it may take a particular amount of time to transfer the data to and from the electronic device 1200. In addition, the memory 1140 may be a first type of memory device (e.g., SRAM), and the memory 1210 may be different type of memory devices (e.g., DRAM. Therefore, it may take longer to access data stored in the memory 1210 than to access the data stored in the memory 1140.

According to embodiments, fused layer execution may refer to an optimization technique for NNs in which where multiple consecutive layers of a neural network are combined into a single external memory access. For example, according to fused-layer execution, multiple layers may be executed in a fused manner by forwarding the partial result of a layer to the next layer without storing the result to off-chip memory. This fusion may reduce the overhead associated with executing each layer separately, such as memory access and data transfer, and may improve the efficiency and performance of the NN model, particularly on specialized hardware such as NN processors and NN accelerators. By fusing layers, the intermediate data between may not be stored in external memory, but instead may be maintained in the internal memory, which may reduce memory bandwidth usage and can lead to faster execution.

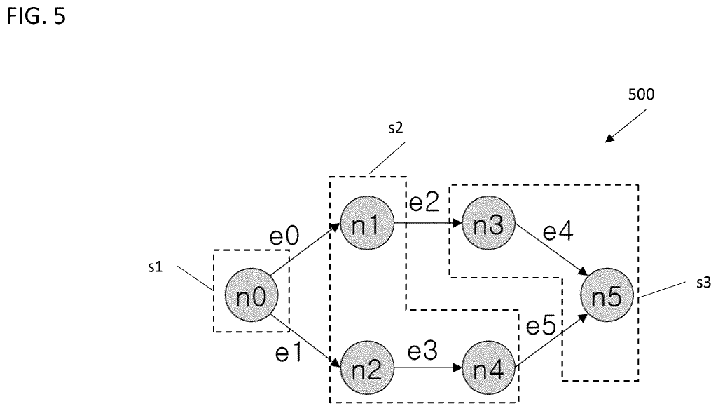

FIG. 5 shows an example DAG which is divided into subgraphs, according to embodiments. According to embodiments, when fused layer execution is used with the NN model 1110, a DAG representing the NN model 1110 may represent the fused layers using subgraphs. According to embodiments, the nodes included in a subgraph may represent layers of the NN model 1110 which are fused together, and the edges which are internal to the subgraph may be referred to as internal edges, and may represent intermediate data that is stored in the memory 1140 (e.g., the internal memory) without being transferred to the memory 1210 (e.g., the external memory). In addition, edges which enter or exit a subgraph may be referred to as external edges or barrier edges, and may represent intermediate data that is transferred to the memory 1210 (e.g., the external memory) before being executed by a next layer of the NN model 1110.

For example, as shown in FIG. 5, the DAG 500 may include the nodes n0 through n5 and the edges e0 through e5 from the DAG 400 of FIG. 4. In addition, in the DAG 500, the nodes n0 through n5 may be divided into a subgraph s1 including the node n0, a subgraph s2 including the node n1, the node n2, and the node n4, and a subgraph s4 including the node n3 and the node n5. Therefore, the edges e0, e1, e2, and e5 may be barrier edges, and the edges e3 and e4 may be internal edges.

As a result, when the NN model 1110 is executed using fused layer execution according to the DAG 500, the intermediate data generated by the node n0 may be transferred to the memory 1210 (e.g., the external memory), and may be obtained from the memory 1210, before it is provided as input to the node n1 and the node n2. Similarly, the intermediate data generated by the node n1 may be transferred to the memory 1210 before it is provided as input to the node n3, and the intermediate data generated by the node n4 may be transferred to the memory 1210 before it is provided as input to the node n5. However, the intermediate data generated by the node n2 may be stored in the memory 1140 (e.g., the internal memory) and may be immediately provided to the node n4 without being transferred to the memory 1210. Similarly, the intermediate data generated by the node n3 may be stored in the memory 1140 and may be immediately provided to the node n5 without being transferred to the memory 1210. In some embodiments, a subgraph which is used to represent one or more layers which are fused according to fused layer execution may be referred as a sequence.

According to embodiments, the problem of determining how to fuse layers in an NN may be referred to as the fused layer execution problem. As discussed above, solving the fused layer problem may be very challenging. For example, as the NN is divided into sequences, the sequences may affect each other, and it may therefore be very difficult to build an analytical model the we can evaluate the derivative of the problem, or find an algorithm that can solve the problem in linear runtime. For example, a size of the search space for the different solutions may be represented as 2ⁿ, where n denotes the number of layers in the NN.

Therefore, embodiments may relate to a process for optimizing execution of the NN model 1110 by defining the fused layer execution problem may be defined as an HPO problem, and then using BBO algorithms to solve it.

For example, according to embodiments, a hyperparameter may be assigned to each edge in the DAG representing the NN model 1110, which may be used to indicate whether the edge corresponds to a barrier of a subgraph. For example, each hyperparameter may be, or may include, a Boolean parameter, which may be defined as “{#edge} _is_barrier”, and which may have one of two values, for example a value indicating “true” and a value indicating “false”. As a result, a hyperparameter assigned to an edge may indicate whether intermediate data corresponding to the edge is assigned to the memory 1140 (e.g., the internal memory) or the memory 1210 (e.g., the external memory).

According to embodiments, the DAG may be modified by removing edges having a hyperparameter value indicating “true” (e.g., indicating that the edge is a barrier edge) to obtain a DAG which includes at least one disconnected subgraph. Each disconnected subgraph may be a sequence.

For example, in order to perform a BBO process (or any other HPO process) on the NN model 1110, the electronic device 1200 may iteratively determine a set of hyperparameters that define the corresponding DAG as a set of disconnected subgraphs, and run the DAG in a performance simulator that produces performance metrics. In embodiments, these performance metrics may relate to at least one from among a latency, a memory bandwidth, and a power consumption corresponding to the NN model 1110, but embodiments are not limited thereto. Over multiple iterations, electronic device 1200 may use the BBO to learn a correlation between the hyperparameters and the performance metrics, and choose the optimal hyperparameters in order to optimize (e.g., minimize and/or maximize) the objective function.

In some embodiments, the objective function used to perform the BBO (or the HPO) may be a multi-objective function with multiple constraints. For example, the objective function may seek to minimize latency and memory bandwidth while maintaining a power consumption below a certain threshold power consumption (e.g., 10 millijoules), but embodiments are not limited thereto.

By using an iterative approach, embodiments may provide a flexible optimization level based on compute budget and time budget. For example, embodiments may not evaluate the entire search space (e.g., 2ⁿ potential solutions), and instead may only evaluate a limited amount of sequences at a time. According to embodiments, the iterative nature of BBO may allow intermediate results of the optimization process to be considered. Accordingly, by controlling the number of iterations, embodiments may allow the level and/or quality of the optimization to be adjusted.

Accordingly, embodiments may allow a sequence to be selected with performance metrics (e.g., power, latency and/or bandwidth) for a given amount of computational or time resources, or the same performance metrics for a lower amount of resources. In addition, embodiments may assist in solving the fused layer executed problem for a native representation of the DAG, and for a transformation of it (e.g., a linearized representation). Embodiments may allow optimization of the objective function as a multi objective problem with constraints. In addition, the optimization may be performed for various different situations or applications of the NN model 1110, which may enable hardware acceleration in various different products.

Although examples relating to NNs are provided above, embodiments are not limited thereto. For example, embodiments may be applied to any computation which may be represented as a DAG. In addition, embodiments may be applied to any device which may perform such a computation, for example a graphics processing unit (GPU), a neural processing unit (NPU), a data processing unit (DPU), and the like.

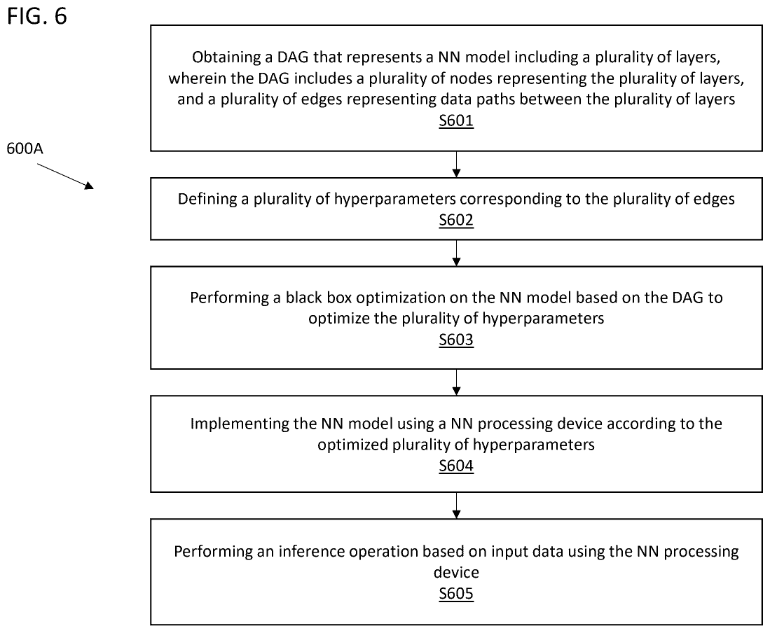

FIG. 6 is a flowchart of an example process for performing NN optimization, according to embodiments. In some implementations, one or more process blocks of FIG. 6 may be performed by any of the elements discussed above, for example one or more of the NN processing device 1100, the electronic device 1200, and any of the components included therein.

As shown in FIG. 6, at operation S601, the process 600 may include obtaining a DAG that represents a NN model including a plurality of layers. In embodiments, the DAG may include a plurality of nodes representing the plurality of layers, and a plurality of edges representing data paths between the plurality of layers. In embodiments, the NN model may correspond to the NN model 1110 discussed above, and the DAG may correspond to any of the DAGs discussed above, for example the DAG 400.

As further shown in FIG. 6, at operation S602, the process 600 may include defining a plurality of hyperparameters corresponding to the plurality of edges.

As further shown in FIG. 6, at operation S603, the process 600 may include performing a black box optimization on the NN model based on the DAG to optimize the plurality of hyperparameters.

As further shown in FIG. 6, at operation S604, the process 600 may include implementing the NN model using a NN processing device according to the optimized plurality of hyperparameters. In embodiments, the NN processing device may correspond to the NN processing device 1100 discussed above.

As further shown in FIG. 6, at operation S605, the process 600 may include performing an inference operation based on input data using the NN processing device.

In embodiments, the NN model may be trained before the black box optimization is performed, and may include least one of a DNN and a CNN.

In embodiments, the plurality of layers may correspond to plurality of NN operations, and the plurality of NN operations may include at least one from among a matrix multiplication, a convolution, and an activation function.

In embodiments, the NN processing device may include a NN processor, an internal memory, and an interface configured to communicate with an external memory. In embodiments, NN processor may correspond to the NN processor 1130, the internal memory may correspond to the memory 1140, and the external memory may correspond to the memory 1210 discussed above.

In embodiments, the optimized plurality of hyperparameters may indicate whether, during the performing of the inference operation, data corresponding to the plurality of edges is transferred to the external memory before being input to a next layer of the plurality of layers.

In embodiments, the plurality of nodes may include a first node corresponding to a first layer of the NN model and a second node corresponding to a second layer of the NN model, the plurality of edges may include a first edge corresponding to intermediate data that is output from the first node and input to the second node during the performing of the inference operation, and the optimized plurality of hyperparameters may include a first hyperparameter corresponding to the first edge.

In embodiments, the optimized plurality of hyperparameters may specify a plurality of subgraphs into which the DAG is divided, and a value of the first hyperparameter may indicate whether the first node and the second node are included in a same subgraph of the plurality of subgraphs.

In embodiments the performing of the black box optimization may include adjusting the plurality of hyperparameters to minimize or maximize an objective function corresponding to at least one from among a latency associated with the NN model, a bandwidth associated with the NN model, a power consumption associated with the NN model, and a resource consumption associated with the NN model.

In embodiments, the black box optimization may be performed according to at least one from among a random search, a Bayesian optimization, and an evolutionary algorithm.

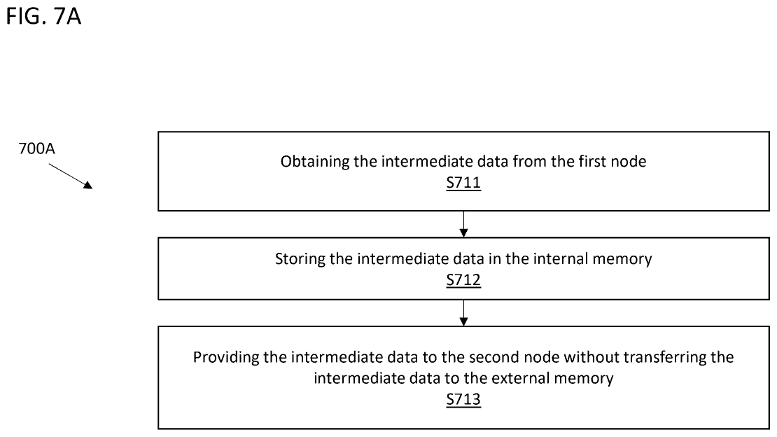

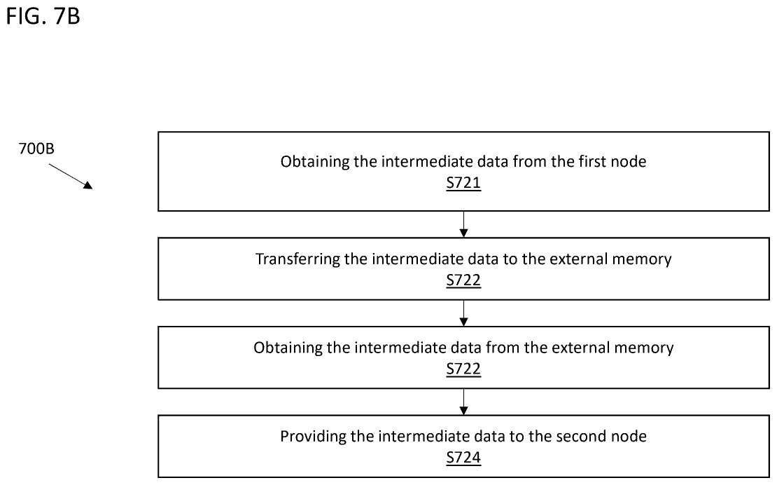

FIGS. 7A and 7B are a flowcharts illustrating examples of performing an inference operation using an optimized NN, according to embodiments. In embodiments, one or more of the operations illustrated in FIGS. 7A and 7B may be performed as part of operation S605 discussed above.

According to embodiments, FIG. 7A may relate to an example in which the DAG includes a first edge connecting a first node to a second node, and further indicates that the first edge is an internal edge. For example, in the description of FIG. 7A, the first node may correspond to the node n2, the second node may correspond to the node n4, and the first edge may correspond to the edge e3. As another example, in the description of FIG. 7A, the first node may correspond to the node n3, the second node may correspond to the node n5, and the first edge may correspond to the edge e4.

As shown in FIG. 7A, at operation S711, the process 700 may include obtaining the intermediate data from the first node.

As further shown in FIG. 7A, at operation S712, the process 700 may include storing the intermediate data in the internal memory.

As further shown in FIG. 7A, at operation S713, the process 700 may include providing the intermediate data to the second node without transferring the intermediate data to the external memory.

According to embodiments, FIG. 7B may relate to an example in which the first edge is a barrier edge. According to embodiments, FIG. 7B may relate to an example in which the DAG includes a first edge connecting a first node to a second node, and further indicates that the first edge is an external edge. For example, in the description of FIG. 7B, the first node may correspond to the node n0, the second node may correspond to the node n1 or the node n2, and the first edge may correspond to the edge e0 or the edge e1. As another example, in the description of FIG. 7B, the first node may correspond to the node n1, the second node may correspond to the node n3, and the first edge may correspond to the edge e2. As yet another example, in the description of FIG. 7B, the first node may correspond to the node n4, the second node may correspond to the node n5, and the first edge may correspond to the edge e5.

As shown in FIG. 7B, at operation S721, the process 700 may include obtaining the intermediate data from the first node.

As further shown in FIG. 7A, at operation S722, the process 700 may include transferring the intermediate data to the external memory.

As further shown in FIG. 7A, at operation S723, the process 700 may include obtaining the intermediate data from the external memory.

As further shown in FIG. 7A, at operation S724, the process 700 may include providing the intermediate data to the second node.

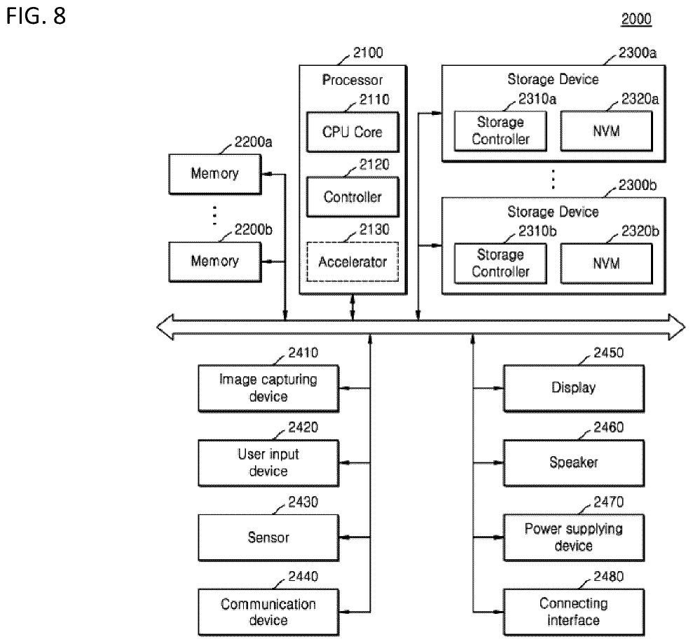

FIG. 8 is a block diagram illustrating a system 2000, according to embodiments. The system 2000 of FIG. 8 may be a mobile system, such as a mobile phone, a smartphone, a tablet PC, a wearable device, a healthcare device, or an IoT device. However, the system 2000 of FIG. 8 is not limited to the mobile system and may be at least one of a PC, a laptop computer, a server, a media player, an automotive device, such as a navigation system, and the like.

As shown in FIG. 8, the system 2000 may include a main processor 2100, memories 2200a and 2200b, and storage devices 2300a and 2300b and further include one or more of an image capturing device 2410, a user input device 2420, a sensor 2430, a communication device 2440, a display 2450, a speaker 2460, a power supplying device 2470, and a connecting interface 2480.

The main processor 2100 may control a general operation of the system 2000, and more particularly, control an operation of the other components constituting the system 2000. The main processor 2100 may be implemented by at least one of a general-use processor, an exclusive processor, an AP, and the like.

The main processor 2100 may include one or more CPU cores 2110 and further include a controller 2120 configured to control the memories 2200a and 2200b and/or the storage devices 2300a and 2300b. According to embodiments, the main processor 2100 may further include an accelerator 2130 that may be an exclusive circuit for high-speed data computations, such as an AI data computation. The accelerator 2130 may include at least one of a GPU, a NPU, a data DPU, and the like, and may be implemented by a separate chip physically independent to the other components of the main processor 2100. According to embodiments, the accelerator 2130 may correspond to the NN processing device 1100 discussed above, and the main processor 2100 may correspond to the electronic device 1200 discussed above, but embodiments are not limited thereto.

The memories 2200a and 2200b may be used as a main memory device of the system 2000 and may include a volatile memory, such as SRAM and/or DRAM, or an NVM, such as PRAM and/or RRAM. The memories 2200a and 2200b may be implemented in the same package as the main processor 2100.

The storage devices 2300a and 2300b may function as a nonvolatile storage device storing data regardless of whether power is supplied thereto and may have a relatively larger storage capacity than the memories 2200a and 2200b. The storage devices 2300a and 2300b may include storage controllers 2310a and 2310b and NVMs 2320a and 2320b storing data under control of the controllers 2310a and 2310b, respectively. The NVMs 2320a and 2320b may include two-dimensional (2D) or three-dimensional (3D) vertical NAND (V-NAND) flash memory or other types of NVMs, such as PRAM and/or RRAM.

The storage devices 2300a and 2300b may be included in the system 2000 by being physically separated from the main processor 2100 or implemented in the same package as the main processor 2100. In some embodiments, the storage devices 2300a and 2300b may have a shape, such as a solid state device (SSD) or a memory card, to be detachably coupled to other components of the system 2000 using an interface, such as the connecting interface 2480 to be described below. The storage devices 2300a and 2300b may be devices to which a standard protocol, such as universal flash storage (UFS), embedded multi-media card (eMMC), or non-volatile memory express (NVMe), is applied but are not necessarily limited thereto.

The image capturing device 2410 may capture at least one of a still image and a video, and may include at least one of a camera, a camcorder, a webcam, and the like.

The user input device 2420 may receive various types of data input from a user of the system 2000 and include at least one of a touch pad, a keypad, a keyboard, a mouse, a microphone, and the like.

The sensor 2430 may sense various types of physical amounts acquirable from the outside and convert the sensed physical amounts into electrical signals. The sensor 2430 may include at least one of a temperature sensor, a pressure sensor, an illuminance sensor, a position sensor, an acceleration sensor, a biosensor, a gyroscope sensor, and the like.

The communication device 2440 may transmit and receive signals to and from other devices outside the system 2000 according to various communication protocols. The communication device 2440 may include at least one of an antenna, a transceiver, a modulator/demodulator (MODEM), and the like.

The display 2450 and the speaker 2460 may function as output devices configured to output visual information and auditory information to the user of the system 2000, respectively.

The power supplying device 2470 may appropriately transform power supplied from a battery embedded in the system 2000 and/or an external power source and supply the transformed power to each component in the system 2000.

The connecting interface 2480 may provide a connection between the system 2000 and an external device connected to the system 2000 to exchange data with the system 2000. The connecting interface 2480 may be implemented by various interface schemes, such as an advanced technology attachment (ATA) interface, a serial ATA (SATA) interface, an external SATA (e-SATA) interface, a small computer small interface (SCSI), a serial attached SCSI (SAS), a peripheral component interconnection (PCI) interface, a PCI express (PCIe) interface, an NVMe interface, an Institute of Electrical and Electronics Engineers (IEEE) 1394 interface, a universal serial bus (USB) interface, a secure digital (SD) card interface, a multi-media card (MMC) interface, an eMMC interface, a UFS interface, an embedded UFS (eUFS) interface, and a compact flash (CF) card interface.

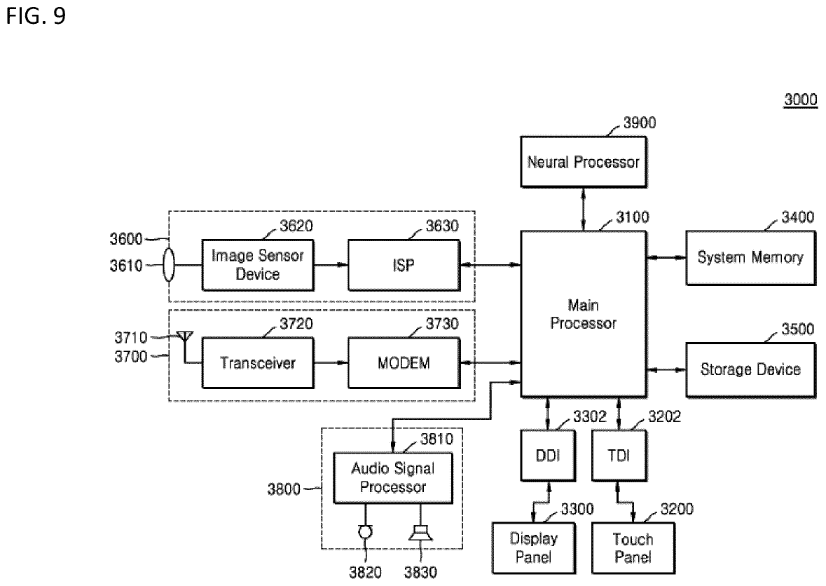

FIG. 9 is a block diagram illustrating an electronic device 3000, according to embodiments. As shown in FIG. 9, the electronic device 3000 may include a main processor 3100, a touch panel 3200, a touch driving circuit 3202, a display panel 3300, a display driving circuit 3302, a system memory 3400, a storage device 3500, an image processor 3600, a communication block 3700, an audio processor 3800, and a neural processor 3900. According to embodiments, the neural processor 3900 may correspond to the NN processing device 1100 discussed above, and the main processor 3100 may correspond to the electronic device 1200 discussed above, but embodiments are not limited thereto.

In an embodiment, the electronic device 3000 may be one of various electronic devices, such as a mobile communication terminal, a personal digital assistant (PDA), a portable media player (PMP), a digital camera, a smartphone, a tablet PC, a laptop computer, and a wearable device.

The touch driving circuit 3202 may control the touch panel 3200. The touch panel 3200 may sense a touch input from a user under control of the touch driving circuit 3202. The display driving circuit 3302 may control the display panel 3300. The display panel 3300 may display image information under control of the display driving circuit 3302.

The system memory 3400 may store data to be used for an operation of the electronic device 3000. For example, the system memory 3400 may temporarily store data processed or to be processed by the main processor 3100. For example, the system memory 3400 may include a volatile memory, such as SRAM, DRAM, or synchronous DRAM (SDRAM), and/or an NVM, such as PRAM, MRAM, ReRAM, or FRAM. In an embodiment, output data output from an ISP 3630 may be stored in the system memory 3400.

The storage device 3500 may store data regardless of power supply. For example, the storage device 3500 may include at least one of various NVMs, such as flash memory, PRAM, MRAM, ReRAM, and FRAM. For example, the storage device 3500 may include an embedded memory of the electronic device 3000 and/or a detachable memory.

The image processor 3600 may receive light through a lens 3610. An image sensor device 3620 and the ISP 3630 included in the image processor 3600 may generate image information regarding an external object based on the received light.

The communication block 3700 may exchange signals with an external device/system using an antenna 3710. A transceiver 3720 and a MODEM 3730 of the communication block 3700 may process signals exchanged with an external device/system according to at least one of various communication protocols, such as long term evolution (LTE), worldwide interoperability for microwave access (WiMax), global system for mobile communication (GSM), code division multiple access (CDMA), Bluetooth, near field communication (NFC), wireless fidelity (Wi-Fi), and radio frequency identification (RFID).

The audio processor 3800 may process an audio signal by using an audio signal processor 3810. The audio processor 3800 may receive an audio input using a microphone 3820 or provide an audio output using a speaker 3830.

The main processor 3100 may control a general operation of the electronic device 3000. The main processor 3100 may control/manage operations of components of the electronic device 3000. The main processor 3100 may process various computations to operate the electronic device 3000. The main processor 3100 may execute one or more instructions of a program or a plurality of NN models stored in a memory. The main processor 3100 according to an embodiment may be a central processing unit (CPU) but embodiments are not limited thereto, and in some embodiments the main processor 3100 may include at least one of an AP, a graphics processing unit (GPU), and the like.

The neural processor 3900 may indicate at least one of an AI-dedicated processor and the like designed as a hardware structure specialized to process a NN model. The neural processor 3900 may generate a NN model, train the NN model, or perform a computation and generate output data by using the NN model based on received input data. The NN model may include various types of NN models, such as a CNN, a DNN, an RNN, an RBM, a DBN, a bidirectional recurrent deep NN (BRDNN), and a deep Q-network, but embodiments are not limited thereto. The NN model may be downloaded from the outside to the electronic device 3000 and stored in the system memory 3400 of the electronic device 3000. In addition, the NN model stored in the system memory 3400 may be updated.

In an embodiment, some of the components of FIG. 9 may be implemented in the form of a system-on-chip and provided as an AP of the electronic device 3000.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

The function blocks used in the detailed description or the drawings may be implemented by software, hardware, or a combination thereof, the software may be machine code, firmware, embedded code, and application software, and the hardware may be a circuit, a processor, a computer, an integrated circuit, integrated circuit cores, a pressure sensor, an inertia sensor, a microelectromechanical system (MEMS), passive devices, or a combination thereof.

While some embodiments have been particularly shown and described herein, it will be understood that various changes in form and details may be made therein without departing from the scope of the following claims.

What is claimed is:

1. A method of performing neural network (NN) optimization, the method comprising:
obtaining a directed acyclic graph (DAG) that represents a NN model comprising a plurality of layers, wherein the DAG comprises a plurality of nodes representing the plurality of layers, and a plurality of edges representing data paths between the plurality of layers;
defining a plurality of hyperparameters corresponding to the plurality of edges;
performing a black box optimization on the NN model based on the DAG to optimize the plurality of hyperparameters;
implementing the NN model using a NN processing device according to the optimized plurality of hyperparameters; and
performing an inference operation based on input data using the NN processing device.

2. The method of claim 1, wherein the NN model is trained before the black box optimization is performed, and
wherein the NN model comprises least one of a deep neural network (DNN) and a convolutional neural network (CNN).

3. The method of claim 1, wherein the plurality of layers correspond to plurality of NN operations, and
wherein the plurality of NN operations comprise at least one from among a matrix multiplication, a convolution, and an activation function.

4. The method of claim 1, wherein the NN processing device comprises a NN processor, an internal memory, and an interface configured to communicate with an external memory, and
wherein the optimized plurality of hyperparameters indicate whether, during the performing of the inference operation, data corresponding to the plurality of edges is transferred to the external memory before being input to a next layer of the plurality of layers.

5. The method of claim 4, wherein the plurality of nodes comprise a first node corresponding to a first layer of the NN model and a second node corresponding to a second layer of the NN model,
wherein the plurality of edges comprise a first edge corresponding to intermediate data that is output from the first node and input to the second node during the performing of the inference operation, and
wherein the optimized plurality of hyperparameters comprise a first hyperparameter corresponding to the first edge.

6. The method of claim 5, wherein the optimized plurality of hyperparameters specify a plurality of subgraphs into which the DAG is divided, and
wherein a value of the first hyperparameter indicates whether the first node and the second node are included in a same subgraph of the plurality of subgraphs.

7. The method of claim 6, wherein based on the value of the first hyperparameter indicating that the first node and the second node are included in the same subgraph, the performing of the inference operation comprises:
obtaining the intermediate data from the first node;
storing the intermediate data in the internal memory; and
providing the intermediate data to the second node without transferring the intermediate data to the external memory.

8. The method of claim 6, wherein based on the value of the first hyperparameter indicating that the first node and the second node are included in different subgraphs of the DAG, the performing of the inference operation comprises:
obtaining the intermediate data from the first node;
transferring the intermediate data to the external memory;
obtaining the intermediate data from the external memory; and
providing the intermediate data to the second node.

9. The method of claim 1, wherein the performing the black box optimization comprises adjusting the plurality of hyperparameters to minimize or maximize an objective function corresponding to at least one from among a latency associated with the NN model, a bandwidth associated with the NN model, a power consumption associated with the NN model, and a resource consumption associated with the NN model.

10. The method of claim 9, the black box optimization is performed according to at least one from among a random search, a Bayesian optimization, and an evolutionary algorithm.

11. A neural network (NN) processing device, comprising:
a NN processor configured to perform NN operations corresponding to a NN model comprising a plurality of layers;
an internal memory; and
an interface configured to communicate with an external memory; and
at least one processor configured to:
obtain input data and parameters of the NN model from the external memory,
perform an inference operation on the input data using the NN processor according to an optimized plurality of hyperparameters to generate output data, and
transfer the output data to the external memory,
wherein the NN model corresponds to a directed acyclic graph (DAG) comprising a plurality of nodes representing the plurality of layers, and a plurality of edges representing data paths between the plurality of layers,
wherein the optimized plurality of hyperparameters correspond to the plurality of edges, and are obtained by performing a black box optimization on the NN model based on the DAG.

12. The NN processing device of claim 11, wherein the NN model is trained before the black box optimization is performed, and
wherein the NN model comprises least one of a deep neural network (DNN) and a convolutional neural network (CNN).

13. The NN processing device of claim 11, wherein the plurality of layers correspond to plurality of NN operations, and
wherein the plurality of NN operations comprise at least one from among a matrix multiplication, a convolution, and an activation function.

14. The NN processing device of claim 11, wherein the optimized plurality of hyperparameters indicate whether, during the performing of the inference operation, data corresponding to the plurality of edges is transferred to the external memory before being input to a next layer of the plurality of layers.

15. The NN processing device of claim 14, wherein the plurality of nodes comprise a first node corresponding to a first layer of the NN model and a second node corresponding to a second layer of the NN model,
wherein the plurality of edges comprise a first edge corresponding to intermediate data that is output from the first node and input to the second node during the performing of the inference operation, and
wherein the optimized plurality of hyperparameters comprise a first hyperparameter corresponding to the first edge.

16. The NN processing device of claim 15, wherein the optimized plurality of hyperparameters specify a plurality of subgraphs into which the DAG is divided, and
wherein a value of the first hyperparameter indicates whether the first node and the second node are included in a same subgraph of the plurality of subgraphs.

17. The NN processing device of claim 16, wherein based on the value of the first hyperparameter indicating that the first node and the second node are included in the same subgraph, the at least one processor is further configured to:
obtain the intermediate data from the first node;
store the intermediate data in the internal memory; and
provide the intermediate data to the second node without transferring the intermediate data to the external memory.

18. The NN processing device of claim 16, wherein based on the value of the first hyperparameter indicating that the first node and the second node are included in different subgraphs of the DAG, the at least one processor is further configured to:
obtain the intermediate data from the first node;
transfer the intermediate data to the external memory;
obtain the intermediate data from the external memory; and
provide the intermediate data to the second node.

19. The NN processing device of claim 11, wherein the performing the black box optimization comprises adjusting an initial plurality of hyperparameters corresponding to the DAG to minimize or maximize an objective function corresponding to at least one from among a latency associated with the NN model, a bandwidth associated with the NN model, a power consumption associated with the NN model, and a resource consumption associated with the NN model, and
wherein the black box optimization is performed according to at least one from among a random search, a Bayesian optimization, and an evolutionary algorithm.

20. An electronic device for performing neural network (NN) optimization, the electronic device comprising:
at least one processor; and
a memory configured to store instructions which, when executed by the at least one processor, cause the electronic device to:
obtain a directed acyclic graph (DAG) that represents a NN model comprising a plurality of layers, wherein the DAG comprises a plurality of nodes representing the plurality of layers, and a plurality of edges representing data paths between the plurality of layers,
define a plurality of hyperparameters corresponding to the plurality of edges,
perform a black box optimization on the NN model based on the DAG to optimize the plurality of hyperparameters,
implement the NN model using a NN processing device according to the optimized plurality of hyperparameters, and
perform an inference operation based on input data using the NN processing device.
